(19) United States
(12) Patent Application Publication
(10) Pub. No.: US 2006/0072765 A1
(43) Pub. Date: Apr. 6, 2006

(54) Acoustic system, control method therefor, program for implementing the method, and storage medium storing the program

(75) Inventor: Motoyuki Shibutani, Hamamatsu-shi (JP)

Correspondence Address: HARNESS, DICKEY & PIERCE, P.L.C., P.O. BOX 828, BLOOMFIELD HILLS, MI, 48303, US

(73) Assignee: Yamaha Corporation

(21) Appl. No.: 11/236,751

(22) Filed: Sep. 27, 2005

(30) Foreign Application Priority Data
Sep. 27, 2004 (JP) 2004-280333

(51) Int. Cl. H04R 29/00; H04R 3/00

(52) U.S. Cl. 381/59; 381/96; 381/111

(57) ABSTRACT

An acoustic system that is capable of forming a desired sound field and sound pressure as desired and in a flexible manner depending on the situation when speakers are newly installed and when installed speakers are increased or decreased later. A plurality of speaker units each include a plurality of speakers. Delay processing is performed on audio signals to be input to the respective speakers. A controller unit detects a connection status of the plurality of speaker units and also detects the array pattern of the plurality of speaker units from speaker unit array patterns stored in advance. The controller unit then outputs a sound field control instruction for realizing a desired sound field based on the detected array pattern to the plurality of speaker units.

### BACKGROUND OF THE INVENTION

1. Field of the Invention

The present invention relates to an acoustic system in which a plurality of acoustic units such as speakers are arranged to form a desired sound field, a control method therefor, a program for implementing the method, and a storage medium storing the program.

2. Description of the Related Art

Conventionally, a variety of acoustic apparatuses and acoustic systems that form a desired sound field have been devised.

In Japanese Laid-Open Patent Publications (Kokai) Nos. H07-154893 and H05-91596, there is disclosed a speaker system that is comprised of a plurality of speakers (sounding elements) arranged on a predetermined plane, and a signal processor that performs predetermined signal processing on audio signals to be input to the speakers. In this speaker system, the plurality of speakers are arranged in a predetermined array on a predetermined plane such as a wall, and delay processing is performed on each of audio signals to be input to the speakers, so that a desired sound field is formed.

However, the conventional acoustic apparatuses and acoustic systems have problems to be solved as described below.

In the speaker system disclosed in Japanese Laid-Open Patent Publications (Kokai) Nos. H07-154893 and H05 -91596, the necessary number of speakers are arranged for a space where a sound field and a sound pressure are required, so that a desired sound field and sound pressure can be formed. However, each time the speakers are arranged in a array depending on the situation, audio signal control to form a new desired sound field and sound pressure must be set again. That is, audio signals to be input to the respective speakers cannot be controlled in a flexible manner depending on the purpose of use and the situation desired by a user. For example, the number of speakers required and signal processing on audio signals to be input to the respective speakers vary according to whether a sound field is formed across the entire room or the half of the room. In this case, in the speaker system disclosed in Japanese Laid-Open Patent Publications (Kokai) Nos. H07-154893 and H05-91596, the arrangement of speakers and signal processing on audio signals must be set again each time a new sound field is formed. This problem arises when speakers are newly installed for the first time, when additional speakers are installed, and when installed speakers are decreased.

### SUMMARY OF THE INVENTION

It is therefore an object of the present invention to provide an acoustic system that is capable of forming a desired sound field and sound pressure as desired and in a flexible manner depending on the situation when speakers are newly installed and when installed speakers are increased or decreased later.

To attain the above object, in a first aspect of the present invention, there is provided an acoustic system comprising a plurality of acoustic units each comprising a plurality of acoustic elements functioning as speakers, and a signal processing device that performs at least delay processing on audio signals to be input to the plurality of acoustic elements, and a control unit that detects a connection status of the plurality of acoustic units, and detects an array pattern of the plurality of acoustic units connected to the control unit from array patterns of the plurality of acoustic units stored in advance, and outputs a sound field control instruction for realizing a desired sound field based on the detected array pattern to the plurality of acoustic units.

With the arrangement of the acoustic system according to the first aspect of the present invention, in the case where a plurality of acoustic units are arranged in an array, the number of acoustic units in use and the array pattern of the plurality of acoustic units are detected. For example, the number of acoustic units arranged in a horizontal direction, the number of acoustic units arranged in a vertical direction, and array information such as the order in which the acoustic units are arranged are detected. In accordance with the detection results, the control unit generates a sound field control instruction for performing delay processing and amplitude processing on audio signals input to the acoustic units so that a desired sound field can be formed in a space (reproduction space) where a sound field is required. Responsive to the sound field control instruction, the acoustic units perform predetermined delay processing and amplitude processing on respective audio signals input thereto. Here, each acoustic unit is formed of a plurality of acoustic elements arranged therein as units smaller than the acoustic units, and delay processing and amplitude processing are performed on audio signals input to the respective acoustic elements. Then, the acoustic elements of each acoustic unit sound based on the respective audio signals on which the delaying processing and the amplitude processing have been performed, so that a desired sound field can be formed. When there is a change in the number of acoustic units arranged and/or in the array pattern of the plurality of the acoustic units, this change is detected, and a sound field control instruction for forming a desired sound field according to a new array pattern is generated.

Specifically, with the arrangement of the acoustic system according to the first aspect of the present invention, the number of acoustic units arranged in an array and connected and the array pattern of the acoustic units are detected, and delay processing and amplitude processing suited to the detection results are performed with respect to each of the acoustic elements of each acoustic unit. As a result, it is possible to construct an acoustic system that forms a desired sound field by changing delay processing and amplitude processing in a flexible manner depending on the array and connection status of acoustic units.

Preferably, the acoustic system comprises a storage device that stores the array patterns of the plurality of acoustic units and signal control parameters corresponding thereto, and the control unit reads out corresponding signal control parameters from the storage device, based on the detected array pattern, to generate the sound field control instruction.

With this arrangement, since acoustic unit array patterns and signal control parameters corresponding thereto are stored in advance, the control unit can immediately generate a sound field control instruction with ease merely by reading out the acoustic unit array patterns and the signal control parameters corresponding thereto.

Also preferably, the plurality of acoustic units comprise one master acoustic unit and other slave acoustic units, the control unit being provided in the master acoustic unit.

With this arrangement, since the control unit is provided in the master acoustic unit, the number of physical component elements constituting the entire acoustic system can be smaller than in the case where the control unit and the master acoustic unit are configured as separate units.

To attain the above object, in a second aspect of the present invention, there is provided a control method for an acoustic system comprising a plurality of acoustic units each comprising a plurality of acoustic elements functioning as speakers, and a controller unit connected to the plurality of acoustic units, comprising a signal processing step of performing at least delay processing on audio signals to be input to the plurality of acoustic elements, a detecting step of detecting a connection status of the plurality of acoustic units, and detecting an array pattern of the plurality of acoustic units connected to the controller unit from array patterns of the plurality of acoustic units stored in advance, and an outputting step of outputting a sound field control instruction for realizing a desired sound field based on the detected array pattern to the plurality of acoustic units.

To attain the above object, in a third aspect of the present invention, there is provided a program executable by an acoustic system comprising a plurality of acoustic units each comprising a plurality of acoustic elements functioning as speakers and a controller unit connected to the plurality of acoustic units, comprising a signal processing module for performing at least delay processing on audio signals to be input to the plurality of acoustic elements, a detecting module for detecting a connection status of the plurality of acoustic units, and detecting an array pattern of the plurality of acoustic units connected to the controller unit from array patterns of the plurality of acoustic units stored in advance, and an outputting module for outputting a sound field control instruction for realizing a desired sound field based on the detected array pattern to the plurality of acoustic units.

To attain the above object, in a fourth aspect of the present invention, there is provided a storage medium storing a computer-readable storage medium storing a program executable by an acoustic system comprising a plurality of acoustic units each comprising a plurality of acoustic elements functioning as speakers, and a controller unit connected to the plurality of acoustic units, comprising, a signal processing module for performing at least delay processing on audio signals to be input to the plurality of acoustic elements, a detecting module for detecting a connection status of the plurality of acoustic units, and detecting an array pattern of the plurality of acoustic units connected to the controller unit from array patterns of the plurality of acoustic units stored in advance, and an outputting module for outputting a sound field control instruction for realizing a desired sound field based on the detected array pattern to the plurality of acoustic units.

The above and other objects, features, and advantages of the invention will become more apparent from the following detained description taken in conjunction with the accompanying drawings.

### BRIEF DESCRIPTION OF THE DRAWINGS

FIG. 1 is a perspective view schematically showing the arrangement of an acoustic system according to an embodiment of the present invention;

FIG. 2 is a block diagram schematically showing the circuitry of the acoustic system in FIG. 1;

FIG. 3A is a diagram showing a state in which directivity is set in the case where there is one speaker unit;

FIG. 3B is a diagram showing a state in which the directivity is set in the case where there are two speaker units;

FIG. 4 is a flow chart showing a main process carried out by a main controller appearing in FIG. 2;

FIG. 5 is a conceptual diagram showing parameters stored in a memory appearing in FIG. 2;

FIG. 6A is a perspective view showing a state in which n speaker units are connected to a controller unit appearing in FIG. 1; and

FIG. 6B is a perspective view showing a state in which n×(m+1) speaker units are connected to the controller unit appearing in FIG. 1.

### DETAILED DESCRIPTION OF THE PREFERRED EMBODIMENTS

The present invention will now be described with reference to the drawings showing a preferred embodiment thereof. It is assumed in the following description that two speakers are used, but the number of speakers used is not limited to two insofar a plurality of speakers are used.

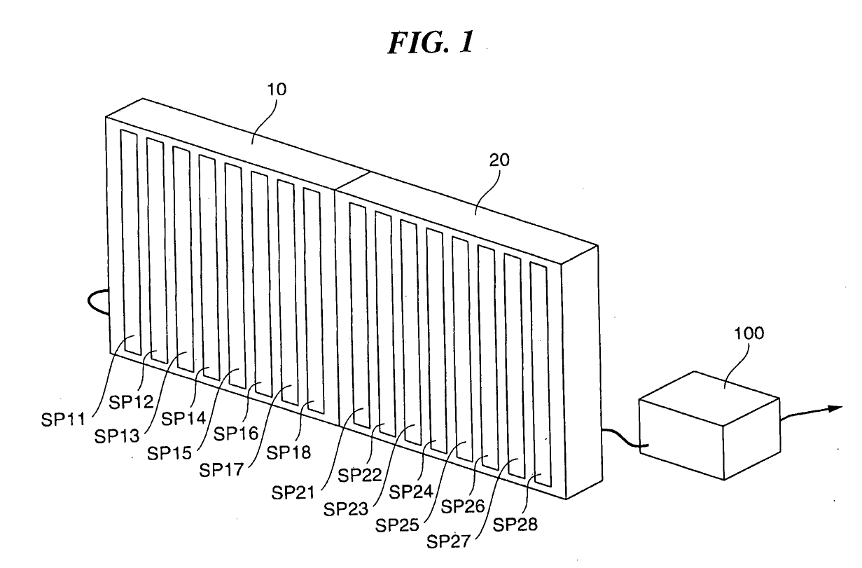

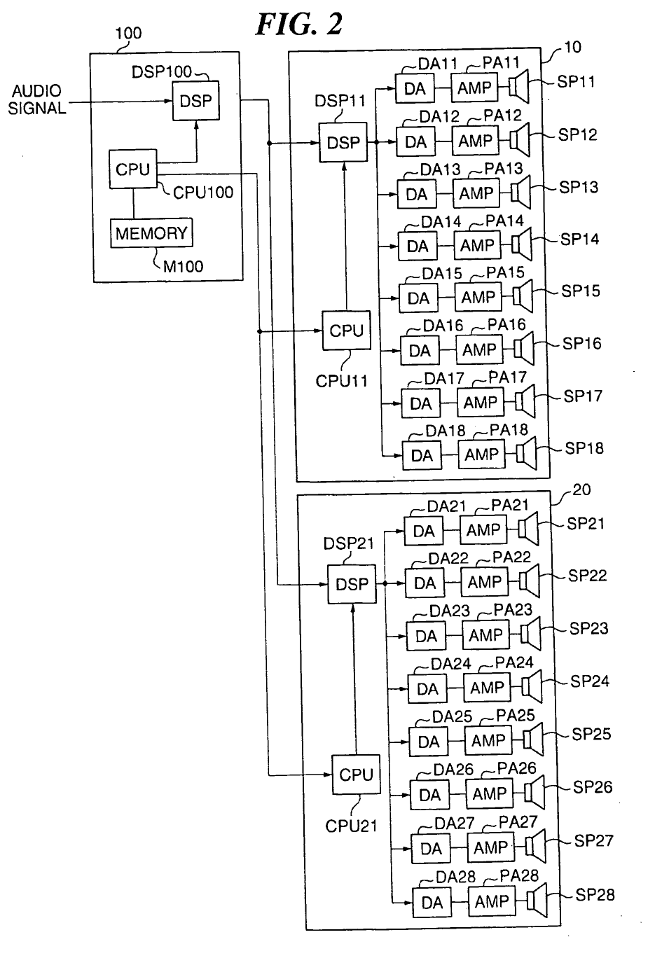

FIG. 1 is a perspective view schematically showing the arrangement of an acoustic system according to an embodiment of the present invention. FIG. 2 is a block diagram schematically showing the circuitry of the acoustic system in FIG. 1.

As shown in FIG. 1, the acoustic system according to the present embodiment is comprised of two electrostatic flat speaker units (hereinafter simply referred to as “the speaker units”) 10 and 20, and a controller unit 100 that is electrically connected to the speaker units 10 and 20. The speaker units 10 and 20 correspond to “acoustic units” as recited in appended claims, and the controller unit 100 corresponds to a “control unit” as recited in appended claims.

The controller unit 100 is comprised of a main controller CPU100, a signal processing section DSP100, and a memory M100 that stores signal control parameters with respect to speaker unit array patterns and signal control parameters for reproduction spaces corresponding to the respective array patterns.

The main controller CPU100 is connected to respective local controllers CPU11 and CPU21 of the speaker units 10 and 20 and performs signal processing described below.

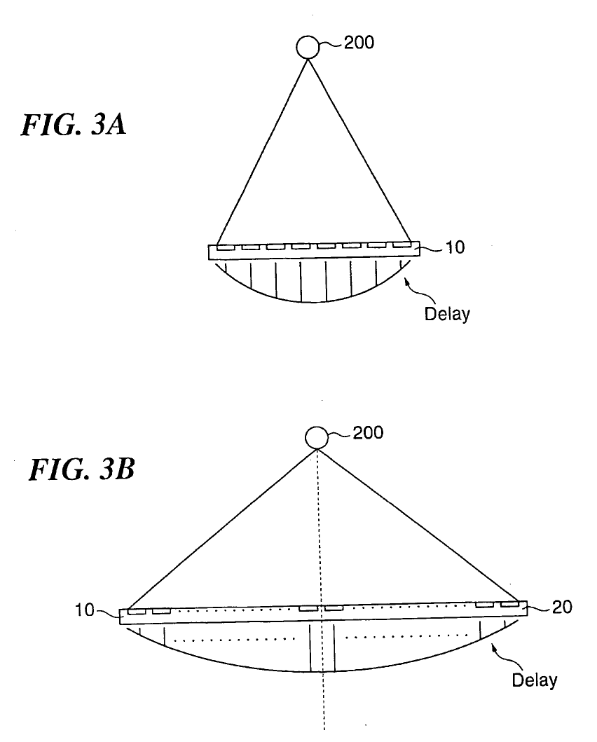

FIG. 3A is a diagram showing a state in which directivity is set in the case where there is one speaker unit, and FIG. 3B is a diagram showing a state in which the directivity is set in the case where there are two speaker units.

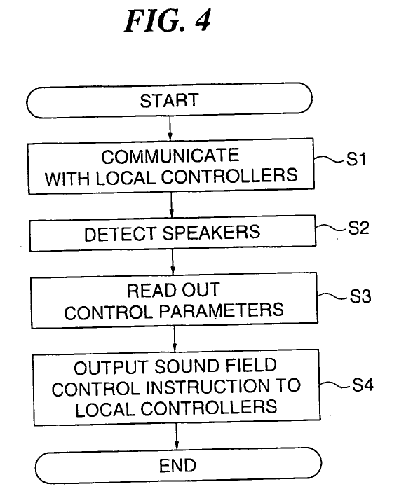

FIG. 4 is a flow chart showing a main process carried out by the main controller appearing in FIG. 2.

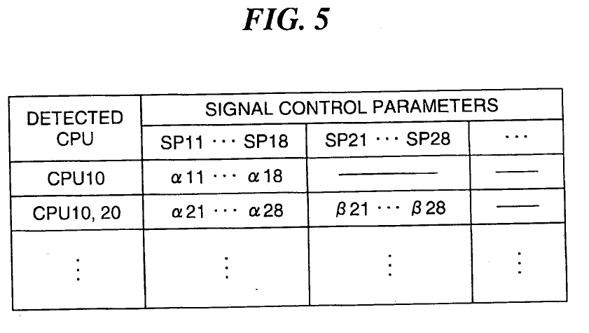

FIG. 5 is a conceptual diagram showing parameters stored in the memory M100 appearing in FIG. 2.

The main controller CPU100 carries out communication with the local controllers CPU11 and CPU21 in predetermined timing (step S1). On this occasion, if the local controllers CPU11 and CPU21 are connected to the main controller CPU100, connection confirmation signals are returned, and the main controller CPU100 detects the connection of the local controllers CPU11 and CPU21, i.e. the connection of the speaker units 10 and 20 (step S2). In this case, arrangement numbers are assigned in advance to the respective speaker units (local controller CPUs), and when the connection confirmation signals are returned, the array patterns are notified so that the array pattern of the speaker units can be detected by the main controller CPU100.

Then, the main controller CPU100 reads out signal control parameters corresponding to the detected arrangement of the local controllers (speaker units) from the memory M100 (step S3).

As shown in FIG. 5, detected local controller CPU patterns (array patterns) and signal control parameters corresponding thereto are stored in the memory M100. More specifically, signal control parameters such as delay control parameters and amplitude control parameters for speakers SP are stored with respect to each array pattern. For example, in the case where connection of only the local controller CPU11 has been confirmed, signal control parameters for causing only the speaker unit 10 to sound audio signals with a strong directivity toward a listener 200 as shown in FIG. 3A are stored. In the case where connection of the local controllers CPU11 and CPU21 has been confirmed, signal control parameters for causing the speaker units 10 and 20 to sound audio signals with a strong directivity toward the listener 200 as shown in FIG. 3B are stored.

Then, the main controller CPU100 generates a sound field control instruction including delay control parameters and amplitude control parameters for causing the two speaker units 10 and 20 to form a sound field based on signal control parameters for the reproduction space, and outputs the instruction to the local controllers CPU11 and CPU21 (step S4).

Here, the main controller CPU100 may communicate with the local controllers CPU11 and CPU21 by time-sharing to output individual control contents as sound field instructions to the respective local controllers CPU11 and CPU21. Alternatively, the main controller CPU100 may output the control contents to the two local controllers CPU11 and CPU21, as one sound field control instruction. In the latter approach, local controllers that have to receive a sound field control instruction is designated in the sound field control instruction, and the local controllers CPU11 and CPU21 acquire only necessary information in the sound field control instruction in accordance with the contents of the controller designation.

It should be noted that the above described confirmation of local controller CPUs, that is, the confirmation of speaker units connected to the main controller CPU100 may be carried out in the same way when the acoustic system is constructed, or when installed speaker units are increased or decreased later. That is, flexible processing is possible depending on the connection status of speaker units.

The signal processing section DSP100 is connected to an external tone generator such as an audio reproducing apparatus, as well as to the respective signal processing sections DSP11 and DSP21 of the speaker units 10 and 20. The signal processing section DSP100 outputs signals obtained by receiving audio signals in analog format such as reproduced audio signals and converting the audio signals into digital signals, or audio signals in digital format to the respective signal processing sections DSP11 and DSP21 of the speaker units 10 and 20. The signal processing sections DSP11 and DSP21 correspond to a “signal processing device” recited in appended claims.

The speaker unit 10 is comprised of a plurality of electrostatic flat speakers (hereinafter simply referred to as “the speakers”) SP11 to SP18 each of which functions as a speaker by itself. The speakers SP11 to SP18 are rectangular as viewed from front (a rectangle having a longer side and a shorter side), and they are arranged at predetermined intervals along the longer sides thereof, that is, in a direction in which the shorter sides extend. The speaker unit 10 is installed such that the speakers SP11 to SP18 are arranged in a horizontal direction. The speakers SP correspond to “acoustic elements” recited in appended claims.

The speaker unit 10 is further comprised of amplifiers PA11 to PA18 connected to the respective speakers SP11 to SP18, D/A converters DA11 to DA18 connected to the respective amplifiers PA11 to PA18, a signal processing section DSP11 connected to the D/A converters DA11 to DA18, and the local controller CPU11 that controls the signal processing section DSP11. Although in the present embodiment, the speaker unit 10 is comprised of eight speakers SP, eight amplifiers PA, and eight D/A converters DA, the numbers of speakers SP, amplifiers PA, and D/A converters DA are not limited to eight.

An input/output section, not shown, that is connected to each of the local controller CPU11 and the signal processing section DSP11 is formed on an external surface of the speaker unit 10. This input/output section is connected to the controller unit 100 via a cable. Another input/output section is connected to each of the local controller CPU21 and the signal processing section DSP21 of the speaker unit 20 and connected to the controller unit 100 via another cable. Via the distribution cable and the input/output section, a sound field control instruction from the main controller CPU100 of the controller unit 100 is transmitted to the local controller CPU11 of the speaker unit 10, and an audio signal in digital format from the signal processing section DSP100 of the controller unit 100 is transmitted to the signal processing section DSP11 of the speaker unit 10. Also, via the other cable and other input/output section, a sound field control instruction from the main controller CPU100 of the controller unit 100 is transmitted to the local controller CPU21 of the speaker unit 20, and an audio signal in digital format from the signal processing section DSP100 of the controller unit 100 is transmitted to the signal processing section DSP21 of the speaker unit 20.

In accordance with the sound field control instruction from the main controller CPU100, the local controller CPU11 outputs a local signal processing control instruction to the signal processing section DSP11. The local signal processing control instruction is for controlling the relationship in delay and amplitude between audio signals to be input to the respective speakers SP11 to SP18, i.e. a control instruction for realizing the above-mentioned delay control parameters and amplitude control parameters stored in the memory M100.

As mentioned above, the signal processing section SP DSP11 has input thereto the local signal processing control instruction from the local controller CPU11 as well as the digital audio signal from the signal processing section DSP100 of the controller unit 100. In accordance with the local signal processing control instruction input from the local controller CPU11, the signal processing section DSP11 converts the digital audio signal into audio signals for the respective speakers SP11 to SP18. Specifically, the signal processing section DSP11 generates eight audio signals with the same phase and the same amplitude from the input digital audio signal and performs delay control processing and amplitude control processing on the generated audio signals in accordance with the local signal processing control instruction. Then, the signal processing section DSP11 outputs the eight audio signals having a predetermined relationship in delay and amplitude with each other to the D/A converters DA11 to DA18.

Each of the D/A converters DA11 to DA18 converts the input digital audio signal into an analog audio signal and outputs the resulting audio signal to a corresponding one of the amplifiers PA11 to PA18.

Each of the amplifiers PA11 to PA18 amplifies the input analog audio signal and outputs the resulting signal to a corresponding one of the speakers SP11 to SP18. The input audio signals vibrate diaphragms of the speakers SP11 to SP18 to sound tones in directions-toward the front.

With this arrangement, tones sounded from the speakers SP11 to SP18 have a predetermined relationship in delay and amplitude with each other, and according to this relationship in delay and amplitude, a directivity of generated tones in the horizontal direction can be obtained.

The speaker unit 20 is comprised of electrostatic flat speakers SP21 to SP28, amplifiers PA21 to PA28, D/A converters DA21 to DA28, a signal processing section DSP21, and the local controller CPU21. The component elements of the speaker unit 20 are identical in construction with the respective component elements of the speaker unit 10 and are connected to each other in the same manner as the respective component elements of the speaker unit 10.

With this arrangement, tones sounded from the speakers SP21 to SP26 have a predetermined relationship in delay and amplitude with each other, and according to this relationship in delay and amplitude, a desired directivity of generated tones in the horizontal direction can be obtained.

The main controller CPU100 of the controller unit 100 generates a sound field control instruction for performing delay processing and amplitude processing on audio signals to be generated by the entire acoustic system including the speaker units 10 and 20, and the local controllers CPU11 and CPU21 perform delay processing and amplitude processing on audio signals to be input to the respective speakers SP21 to SP18 and SP21 to SP28. Therefore, tones sounded from the respective speakers SP11 to SP18 and SP21 to SP28 of the speaker units 10 and 20 have a predetermined relationship in delay and amplitude with each other. As a result, a predetermined horizontal directivity of tones generated from the speakers SP of the entire acoustic system can be obtained to form a desired sound field and range.

By the way, there may be cases where the user changes the number of speaker units in use so as to obtain a desired sound field and range. For example, to obtain a sound pressure and frequency characteristics that cannot be realized only by speaker units already in use, the user increases the number of speaker units, or when more speaker units than required are connected to the controller unit 100, the user decreases the number of speaker units

Next, a description will be given of the cases where there is a change in the connection status of speaker units as mentioned above.

(1) When there is a change in the number of speaker units from two to n

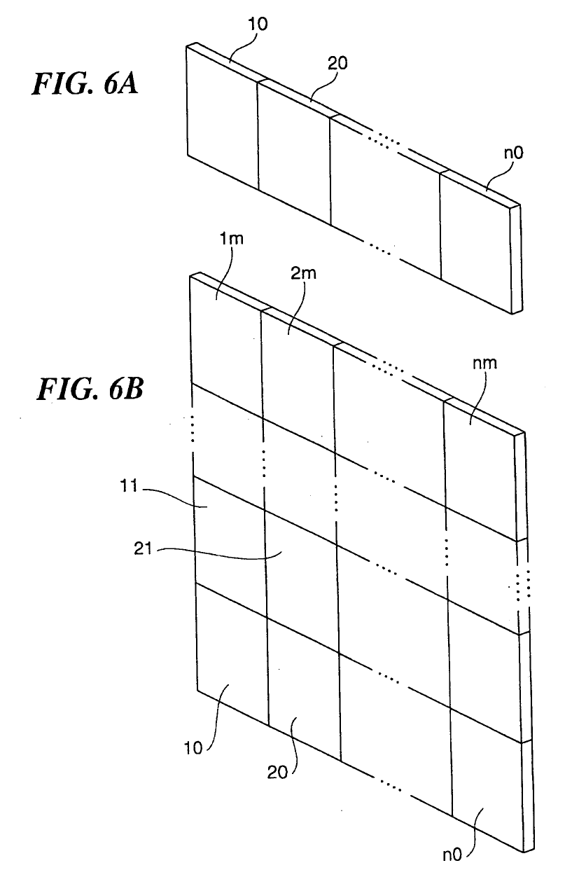

FIG. 6A is a perspective view showing a state in which n speaker units are connected to the controller unit, in which speakers SP of each speaker unit and the controller unit 100 are omitted. When n speaker units 10 to n0 are connected to the controller unit 100 from a state in which the two speaker units 10 and 20 are connected to the controller unit 100, the main controller CPU100 becomes able to communicate with the respective local controllers of the speaker units 10 to n0. Therefore, the main controller CPU100 detects the n local controllers connected to the controller unit 100.

The relationship in position and arrangement between the n speaker units is stored in advance in a memory of the controller unit 100. Upon detecting the n local controllers, the main controller CPU100 reads out the relationship in position and arrangement between the n speaker units and detects the speaker array pattern of the n speaker units connected to the controller unit 100. Then, the main controller CPU100 generates a sound field control instruction for forming a sound field having a desired directivity with the speaker array pattern of the speaker units 10 to n0 of which the connection to the controller unit 100 has been detected, and outputs the generated sound field control instruction to the local controllers of the speaker units 10 to n0. Each of the local controllers outputs a local signal processing control instruction for performing predetermined delay processing and amplitude processing to each of the plurality of speakers provided in the speaker units 10 to n0, based on the input sound field control instruction. In accordance with the local signal processing control instruction, each of the signal processing sections DSP performs delay processing, amplitude processing, and frequency axial direction processing on an audio signal to be input to a corresponding one of the n speaker units 10 to n0. As a result, an optimum sound field can be realized by the n speaker units 10 to n0. Also, due to an increase in the number of speaker units arranged in the horizontal direction, the length of the speaker units as a whole in the horizontal direction is increased, and hence output characteristics in a lower frequency range than the frequency range where sound is reproduced by two speaker units can be improved. As a result, the frequency range over which sound can be reproduced by the acoustic system can be broadened.

It should be noted that in the case where the acoustic system is comprised of n speaker units as mentioned above, whenever the number of speaker units in use and/or the speaker array pattern thereof is changed, speaker units connected to the controller unit 100 and the speaker array pattern of the speaker units are detected by the main controller CPU100, and delay processing and amplitude processing that can realize an optimum directivity of generated tones are performed to form a desired sound field.

(2) When there is a change in the number of speaker units from two to n×(m+1)

FIG. 6B is a perspective view showing a state in which n×(m+1) speaker units are connected to the controller unit, in which speakers SP of each speaker unit and the controller unit 100 are omitted.

When n×(m+1) speaker units 10 to nm are connected to the controller unit 100 from a state in which the two speaker units 10 and 20 are connected to the controller unit 100, the main controller CPU100 becomes able to communicate with the respective local controllers of the speaker units 10 to nm. Therefore, the main controller CPU100 detects the n×(m+1) local controllers connected to the controller unit 100.

The relationship in position and arrangement between the n×(m+1) speaker units is stored in advance in the memory of the controller unit 100. Upon detecting the n×(m+1) local controllers, the main controller CPU100 reads out the relationship in position and arrangement between the n×(m+1) speaker units and detects the speaker array pattern of the n×(m+1) speaker units connected to the controller unit 100. Then, the main controller CPU100 generates a sound field control instruction for forming a sound field having a desired directivity with the detected speaker array pattern of the speaker units 10 to nm of which the connection to the controller unit 100 has been detected and outputs the generated sound field control instruction to the local controllers of the speaker units 10 to nm. Each of the local controllers outputs a local signal processing control instruction for performing predetermined delay processing and amplitude processing to each of the plurality of speakers provided in the speaker units 10 to nm, based on the input sound field control instruction. In accordance with the local signal processing control instruction, each of the signal processing sections DSP performs delay processing, amplitude processing, and frequency axial direction processing on an audio signal to be input to a corresponding one of the n×(m+1) speaker units 10 to nm. As a result, an optimum sound field can be realized by the n×(m+1) speaker units 10 to nm.

Here, the n×(m+1) speaker units 10 to nm are arranged in a two-dimensional array pattern in which n speaker units are arranged in the horizontal direction and (m+1) speaker units are arranged in a vertical direction, and therefore, two-way directivity of generated tones can be realized in two directions, i.e. horizontal and vertical directions.

It should be noted that in the case where the acoustic system is comprised of n×(m+1) speaker units 10 to nm as mentioned above, whenever the number of speaker units in use and/or the speaker array pattern thereof is changed, speaker units connected to the controller unit 100 and the speaker array pattern of the speaker units are detected by the main controller CPU100, and delay processing and amplitude processing that can realize an optimum directivity of generated tones are performed to form a desired sound field in the horizontal and vertical directions.

(3) When there is a change in the number of speaker units from two to one

First, in the state in which the two speaker units 10 and 20 are connected to the controller unit 100, the main controller CPU100 detects the presence of the respective local controllers CPU11 and CPU21 of the two speaker units 10 and 20 in the above described way. Then, the main controller CPU100 generates a sound field control instruction for forming a desired sound field by the two speaker units 10 and 20 and outputs the instruction to the local controllers CPU11 to CPU21.

Here, if the controller unit 100 and the speaker unit 20 are disconnected from each other, the main controller CPU100 becomes unable to communicate with the local controller CPU21. Thus, the main controller CPU100 detects only the local controller CPU11 connected to the controller unit 100, that is, only the speaker unit 10 connected to the controller unit 100. Therefore, the main controller CPU100 generates a sound field control instruction for forming a sound field by only the speaker unit 10 and outputs the instruction to the local controller CPU11.

In accordance with the input sound field control instruction, the local controller CPU11 outputs a local signal processing control instruction for performing predetermined delay processing and amplitude processing to each of the plurality of speakers SP11 to SP18 provided in the speaker unit 10. In accordance with the local signal processing control instruction, the signal processing section DSP11 performs delay processing and amplitude processing on an audio signal to be input to each of the speakers SP11 to SP18. As a result, an optimum sound field can be realized by one speaker unit 10.

As described above, according to the present embodiment, optimum audio signal processing (delay processing and amplitude processing) can be performed with respect to each speaker unit, in particular, each speaker, depending on the number of speaker units connected to the controller unit. As a result, an acoustic system that forms an optimum sound field depending on the connection status of speakers and speaker units can be realized. That is, it is possible to realize an acoustic system that reconstructs an optimum sound field in a flexible manner depending on the arrangement of speakers.

In other words, if the number and arrangement of speakers that can realize reproduction with a desired sound field and range are set, optimum delay processing and amplitude processing can be set according to the set number and arrangement of speakers. As a result, it is possible to configure an acoustic system that combines speaker units according to a reproduction space and therefore realizes the desired sound field and range under optimum conditions.

Although in the above embodiment, the controller unit is configured separately from the speaker units, but may be incorporated in one of the speaker units. In this case, the acoustic system is configured such that one speaker unit with the controller unit incorporated therein is regarded as a master speaker unit (“master acoustic unit” recited in appended claims), and the other speaker units are regarded as slave speaker units (“slave acoustic units” recited in appended claims). In this case as well, the above described effects can be obtained. Further, since the controller unit and the speaker unit are not configured as separate units, the component elements of the acoustic system can be decreased and space and cost can be reduced. In addition, since the acoustic system is comprised merely of speaker units, the degree of freedom in installing the acoustic system can be increased.

Further, although in the above embodiment, the acoustic system is constructed such that a plurality of speakers (speaker units) sound tones, the present invention is not limited to this, but the present invention may be applied as a sound-collecting acoustic system by configuring the circuitry such that the speakers are used as microphones.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of the above described embodiment, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. Alternatively, the program code may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

What is claimed is:

1. An acoustic system comprising:
a plurality of acoustic units each comprising a plurality of acoustic elements functioning as speakers, and a signal processing device that performs at least delay processing on audio signals to be input to said plurality of acoustic elements; and
a control unit that detects a connection status of said plurality of acoustic units, and detects an array pattern of said plurality of acoustic units connected to said control unit from array patterns of said plurality of acoustic units stored in advance, and outputs a sound field control instruction for realizing a desired sound field based on the detected array pattern to said plurality of acoustic units.

2. An acoustic system according to claim 1, comprising:
a storage device that stores the array patterns of said plurality of acoustic units and signal control parameters corresponding thereto, and
wherein said control unit reads out corresponding signal control parameters from said storage device, based on the detected array pattern, to generate the sound field control instruction.

3. An acoustic system according to claim 1, wherein said plurality of acoustic units comprise one master acoustic unit and other slave acoustic units, said control unit being provided in said master acoustic unit.

4. A control method for an acoustic system comprising a plurality of acoustic units each comprising a plurality of acoustic elements functioning as speakers, and a controller unit connected to the plurality of acoustic units, comprising:
a signal processing step of performing at least delay processing on audio signals to be input to the plurality of acoustic elements;
a detecting step of detecting a connection status of the plurality of acoustic units, and detecting an array pattern of the plurality of acoustic units connected to the controller unit from array patterns of the plurality of acoustic units stored in advance; and
an outputting step of outputting a sound field control instruction for realizing a desired sound field based on the detected array pattern to the plurality of acoustic units.

5. A program executable by an acoustic system comprising a plurality of acoustic units each comprising a plurality of acoustic elements functioning as speakers and a controller unit connected to the plurality of acoustic units, comprising:
a signal processing module for performing at least delay processing on audio signals to be input to the plurality of acoustic elements;
a detecting module for detecting a connection status of the plurality of acoustic units, and detecting an array pattern of the plurality of acoustic units connected to the controller unit from array patterns of the plurality of acoustic units stored in advance; and
an outputting module for outputting a sound field control instruction for realizing a desired sound field based on the detected array pattern to the plurality of acoustic units.

6. A computer-readable storage medium storing a program executable by an acoustic system comprising a plurality of acoustic units each comprising a plurality of acoustic elements functioning as speakers, and a controller unit connected to the plurality of acoustic units, comprising:
a signal processing module for performing at least delay processing on audio signals to be input to the plurality of acoustic elements;
a detecting module for detecting a connection status of the plurality of acoustic units, and detecting an array pattern of the plurality of acoustic units connected to the controller unit from array patterns of the plurality of acoustic units stored in advance; and
an outputting module for outputting a sound field control instruction for realizing a desired sound field based on the detected array pattern to the plurality of acoustic units.
